(19) United States
(12) Patent Application Publication
(10) Pub. No.: US 2016/0069752 A1
(43) Pub. Date: Mar. 10, 2016

(54) TEMPERATURE MEASUREMENT APPARATUS AND TEMPERATURE MEASUREMENT METHOD

(71) Applicant: SEIKO EPSON CORPORATION, Tokyo (JP)

(72) Inventor: Sakiko SHIMIZU, Matsumoto-shi (JP)

(21) Appl. No.: 14/850,273

(22) Filed: Sep. 10, 2015

(30) Foreign Application Priority Data
Sep. 10, 2014 (JP) 2014-184519

(51) Int. Cl. G01K 13/00

(52) U.S. Cl. CPC G01K 13/002

(57) ABSTRACT

A temperature measurement apparatus includes a first temperature sensor and a second temperature sensor which are provided at different positions inside a base which is in contact with a surface of a body to be measured, and a calculation processing unit which calculates a temperature of a measurement target position of the body to be measured using respective detected temperatures in the first and second temperature sensors. The calculation processing unit calculates a temperature of the measurement target position of the body to be measured using a heat balance relative coefficient indicating a relative relationship between heat balance characteristics at the respective positions of the first temperature sensor and the second temperature sensor when the base is in contact with the measurement target position and the surface of the body to be measured, and the respective detected temperatures in the first temperature sensor and the second temperature sensor.

### BACKGROUND

1. Technical Field

The present invention relates to a temperature measurement apparatus and the like.

2. Related Art

There are various methods of measuring temperature. For example, when a body to be measured is a human body, as measurement methods for obtaining a body temperature, there are various methods such as a method in which a temperature sensor which is covered with a highly conductive metal cover is in direct contact with a human body surface in the armpit or the like, and a body temperature is obtained from a measured temperature (JP-A-2003-254836), or a method in which a body temperature is obtained by detecting the intensity of infrared light emitted from the inside of the ear (JP-A-11-37854).

However, any measurement method has advantages and disadvantages. In measurement, it is necessary to select an appropriate measurement method in relation to various problems such as an environmental problem of a location where the measurement is performed, a problem of a part set as a measurement target, and a problem of a state of a living body if a body to be measured is the living body. For this reason, as the number of various selectable measurement methods increases, measurement can be performed in all situations.

### SUMMARY

An advantage of some aspects of the invention is to propose a technique for realizing a new method of measuring a temperature of a predetermined position.

A first aspect of the invention is directed to a temperature measurement apparatus including temperature sensors that are respectively provided at a plurality of positions which are different from a position of a predetermined heat source and of which temperatures change when a temperature of the heat source changes; and a calculation processing unit that calculates a temperature of a measurement target position which is different from the position of the heat source and is different from installation positions of the temperature sensors of which temperatures change when a temperature of the heat source changes, using detected temperatures in the temperature sensors.

The invention may be configured as, as an eighth aspect of the invention, a temperature measurement method including detecting temperatures using temperature sensors which are respectively provided at a plurality of positions which are different from a position of a predetermined heat source and of which temperatures change when a temperature of the heat source changes; and calculating a temperature of a measurement target position which is different from the position of the heat source and is different from installation positions of the temperature sensors of which temperatures change when a temperature of the heat source changes, using detected temperatures in the temperature sensors.

According to these aspects of the invention, it is possible to realize a new temperature measurement method of calculating a temperature of a measurement target position using detected temperatures in temperature sensors which are provided at a plurality of positions whose temperatures change when a temperature of a heat source changes.

As a second aspect of the invention, the first aspect of the invention may be configured as the temperature measurement apparatus in which the calculation processing unit calculates a temperature of the measurement target position using relative relationship data indicating a relative relationship between heat balance characteristics at the measurement target position and the positions of the temperature sensors, and the detected temperatures in the temperature sensors.

The relative relationship data is data indicating a relative relationship between the heat balance characteristics at the measurement target position and the positions of the temperature sensors. Here, the heat balance indicates heat transmission, and the heat balance characteristics indicate characteristics of the heat transmission. According to the second aspect, if the relative relationship data is set with high accuracy, it is possible to calculate an accurate temperature of the measurement target position.

As a third aspect of the invention, the second aspect of the invention may be configured as the temperature measurement apparatus, in which the temperature sensors are three or more temperature sensors, and the calculation processing unit selects at least two temperature sensors from the temperature sensors, and calculates a temperature of the measurement target position using the relative relationship data related to a combination of the selected temperature sensors and detected temperatures in the selected temperature sensors.

According to the third aspect of the invention, at least two temperature sensors are selected from the temperature sensors which are disposed at three or more different positions. A temperature of the measurement target position is calculated using the relative relationship data of the heat balance characteristics at the positions of the selected temperature sensors and detected temperatures in the selected temperature sensors. With this configuration, it is possible to select temperature sensors which are suitable for measurement from the temperature sensors disposed at three or more different positions and to calculate a temperature.

As a fourth aspect of the invention, any of the first to third aspects of the invention may be configured as the temperature measurement apparatus, in which the calculation processing unit estimates a temperature of the measurement target position in a steady state on the basis of a plurality of temperatures obtained by performing the calculation at different calculation timings.

According to the fourth aspect of the invention, since a temperature of the measurement target position in the steady state can be obtained even in a non-steady state which does not reach the steady state, it is possible to complete temperature measurement early.

As a fifth aspect of the invention, the fourth aspect of the invention may be configured as the temperature measurement apparatus, in which the calculation processing unit uses a temperature obtained by performing the estimation as an output value in a case where temperatures of the positions of the temperature sensors are in a non-steady state.

According to the fifth aspect of the invention, an estimated temperature is used as an output value in a case of the non-steady state. Therefore, it is possible to use a more reliable temperature as an output value early.

As a sixth aspect of the invention, the fourth or fifth aspect of the invention may be configured as the temperature measurement apparatus, in which the calculation processing unit uses a temperature obtained by performing the calculation as an output value in a case where temperatures of the positions of the temperature sensors are in a steady state.

According to the sixth aspect of the invention, in a case of the steady state, instead of an estimated temperature, a calculated temperature can be used as an output value.

As a seventh aspect of the invention, any of the first to sixth aspects of the invention may be configured as the temperature measurement apparatus, in which the calculation processing unit estimates a detected temperature in a steady state on the basis of the detected temperatures at different calculation timings, and calculates a temperature of the measurement target position using the estimated detected temperature.

According the seventh aspect of the invention, a detected temperature in a steady state is estimated on the basis of the detected temperatures at different calculation timings. Thus, even in the non-steady state, a detected temperature in the steady state can be estimated. For this reason, it is possible to calculate a temperature of the measurement target position early with higher accuracy even in the non-steady state.

### BRIEF DESCRIPTION OF THE DRAWINGS

The invention will be described with reference to the accompanying drawings, wherein like numbers reference like elements.

FIGS. 1A to 1C are diagrams for explaining a principle of temperature calculation.

FIGS. 2A to 2D are diagrams for explaining positions where temperature sensors are installed.

FIGS. 3A to 3D are diagrams illustrating a configuration example of a base.

FIG. 4 is a diagram illustrating a test result.

FIG. 5 is a block diagram illustrating a schematic configuration of a temperature measurement apparatus.

FIG. 6 is a diagram illustrating an example of a data structure of temperature data.

FIG. 7 is a flowchart illustrating a flow of a temperature measurement process.

FIGS. 8A and 8B are diagrams for explaining a modification example.

FIG. 9 is a flowchart illustrating a part of a flow of a temperature measurement process in the modification example.

FIG. 10 is a flowchart illustrating a part of the flow of the temperature measurement process in the modification example.

FIG. 11 is a diagram for explaining an example in which a base is not used.

FIG. 12 is a diagram for explaining an example in which a plurality of measurement target positions are used.

### DESCRIPTION OF EXEMPLARY EMBODIMENTS

### 1. PRINCIPLE

In the present embodiment, a description will be made of a case where a predetermined measurement target position as a temperature measurement target is set as a skin of a living body (person) which is a body to be measured, and a surface temperature is measured. Measurement of a temperature includes two types. In other words, one is “calculation” of a temperature, and the other is “estimation” of a temperature. The “calculation” will be first described, and then the “estimation” will be described.

### 1-1. Principle of Temperature Calculation

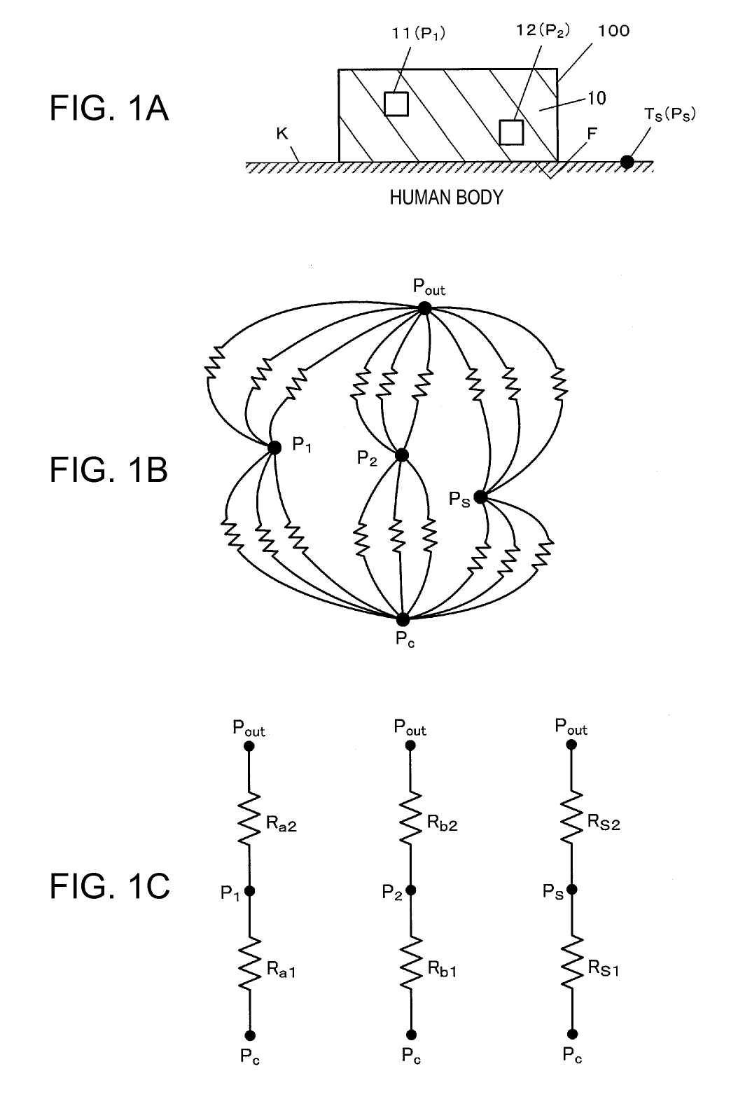

FIGS. 1A to 1C are diagrams for explaining a principle of temperature calculation in the present embodiment. In the present embodiment, as illustrated in FIG. 1A, a contact surface F of a base 100 is in contact with a surface K of a body to be measured which is a temperature measurement target, and thus a surface temperature of the body to be measured is calculated. It is noted that a surface temperature is not measured by a temperature sensor in direct contact with the surface K of the body to be measured.

The base 100 is made of a predetermined material and has a predetermined structure. A configuration example of the base 100 will be described in detail with reference to the drawings. A plurality of temperature sensors are disposed at different positions inside the base 100.

In the examples illustrated in FIGS. 1A to 1C, two temperature sensors including a first temperature sensor 11 and a second temperature sensor 12 are disposed inside the base 100. Hereinafter, positions of the first temperature sensor 11 and the second temperature sensor 12 are respectively referred to as a first detection position P₁ and a second detection position P₂.

As the temperature sensor, a well-known sensor may be employed. For example, not only a sensor using a chip thermistor, a flexible board in which a thermistor pattern is printed, or a platinum temperature measuring resistor, but also a sensor using a thermocouple element, a PN junction element, or a diode may be employed. An electric signal (hereinafter, referred to as a “temperature detection signal”) corresponding to a temperature of the detection position is output from the temperature sensor, and a temperature detected by each temperature sensor is acquired on the basis of the temperature detection signal.

In the present embodiment, the body to be measured is the human body, but may be organic objects such as animals other than the human body, or may be inorganic objects such as a furnace, a pipe, and an engine. In the present embodiment, a position (hereinafter, referred to as a “measurement target position P_{S}”) as a temperature measurement target of the body to be measured is an outer layer part (a surface layer part or a surface). Therefore, in the present embodiment, a skin temperature T_{S} of the human body is a measurement target.

Any position in the external world is referred to as an “any external position”. The external world indicates a measurement environment in which a body to be measured is placed.

It is assumed that an external temperature is lower than an internal temperature T_{C} of the human body. Heat moves from a high temperature side to a low temperature side. For this reason, herein, for example, there may be three heat flow passages including a heat flow passage with a heat source position P_{C} in the human body of an internal temperature or the like as a start point and an any external position Pₒᵤₜ as a finish point. More specifically, there may be a heat flow passage (hereinafter, referred to as a “first heat flow passage”) which reaches the any external position Pₒᵤₜ from the heat source position P_{C} via the first detection position P₁ of the first temperature sensor 11, a heat flow passage (hereinafter, referred to as a “second heat flow passage”) which reaches the any external position Pₒᵤₜ from the heat source position P_{C} via the second detection position P₂ of the second temperature sensor 12, and a heat flow passage (hereinafter, referred to as a “third heat flow passage”) which reaches the any external position Pₒᵤₜ from the heat source position P_{C} via the measurement target position P_{S}.

When heat flows along the first to the third heat flow passages, a procedure thereof is influenced by the inflow of heat from the external world and outflow to the external world. In the present embodiment, the heat exchange is referred to as “heat balance”. If the above-described heat flow passages are modeled in terms of electrical circuits by taking into consideration such heat balance, a heat flow passage model as illustrated in FIG. 1B can be built.

In the heat flow passage model illustrated in FIG. 1B, various passages may be considered as passages from the heat source position P_{C} to the first detection position P₁, and various passages may also be considered as passages from the first detection position P₁ to the any external position Pₒᵤₜ. In the heat flow passage model illustrated in FIG. 1B, each passage is represented as a resistor. This is also the same for the second heat flow passage and the third heat flow passage. Of course, a value of each thermal resistor is not known.

If the heat flow passage model illustrated in FIG. 1B is simplified, models are obtained as illustrated in FIG. 1C. A thermal resistor obtained by combining the thermal resistors between the heat source position P_{C} and the first detection position P₁ is denoted by Rₐ₁, and a thermal resistor obtained by combining the thermal resistors between the first detection position P₁ and the any external position Pₒᵤₜ is denoted by Rₐ₂. A thermal resistor obtained by combining the thermal resistors between the heat source position P_{C} and the second detection position P₂ is denoted by R_{b1}, and a thermal resistor obtained by combining the thermal resistors between the second detection position P₂ and the any external position Pₒᵤₜ is denoted by R_{b2}. A thermal resistor obtained by combining the thermal resistors between the heat source position P_{C} and the measurement target position P_{S} is denoted by R_{S1}, and a thermal resistor obtained by combining the thermal resistors between the measurement target position P_{S} and the any external position Pₒᵤₜ is denoted by R_{S2}.

A temperature of the any external position Pₒᵤₜ is referred to as an “external temperature” and is denoted by Tₒᵤₜ. Detected temperatures in the first temperature sensor 11 and the second temperature sensor 12 are respectively referred to as a “first detected temperature” and a “second detected temperature”, and are denoted by Tₐ and T_{b}.

In the heat flow passage model, the first detected temperature Tₐ may be represented as in the following Equation (1) using the thermal resistors Rₐ₁ and Rₐ₂, the internal temperature T_{C}, and the external temperature Tₒᵤₜ. The second detected temperature T_{b} may be represented as in the following Equation (2) using the thermal resistors R_{b1} and R_{b2}, the internal temperature T_{C}, and the external temperature Tₒᵤₜ. The skin temperature T_{S} may be represented as in the following Equation (3) using the thermal resistors R_{S1} and R_{S2}, the internal temperature T_{C}, and the external temperature Tₒᵤₜ.

Tₐ=Rₐ₂×T_{C}/(Rₐ₁−Rₐ₂)+Rₐ₁×Tₒᵤₜ/(Rₐ₁+Rₐ₂) (1)

T_{b}=R_{b2}×T_{C}/(R_{b1}+R_{b2})+R_{b1}×Tₒᵤₜ/(R_{b1}+R_{b2}) (2)

T_{S}=R_{S2}×T_{C}/(R_{S1}+R_{S2})+R_{S1}×Tₒᵤₜ/(R_{S1}+R_{S2}) (3)

in Equations (1) to (3), coefficients of the external temperature Tₒᵤₜ are replaced with the following Equations (4) to (6).

a=Rₐ₁/(Rₐ₁+Rₐ₂) (4)

b=R_{b1}/(R_{b1}+R_{b2}) (5)

S=R_{S1}/(R_{S1}+R_{S2}) (6)

The coefficient a is represented by a ratio of the thermal resistor Rₐ₁ to all the thermal resistors of the first heat flow passage. This indicates an influence of the heat balance which a heat flow which travels along the first heat flow passage receives from the thermal resistor Rₐ₁, and may be considered as a coefficient indicating heat balance characteristics at the first detection position P₁. This is also the same for the coefficient b and the coefficient S.

Equations (1) to (3) may be respectively rewritten into the following Equations (7) to (9) using the coefficients a, b and S.

Tₐ=(1−a)×T_{C}+a×Tₒᵤₜ (7)

T_{b}=(1−b)×T_{C}+b×Tₒᵤₜ (8)

T_{S}=(1−S)×T_{C}+S×Tₒᵤₜ (9)

If the external temperature Tₒᵤₜ is removed from Equations (7) and (9) which are then solved for the internal temperature T_{C}, this leads to Equation (10). Similarly, Equation (11) is obtained from Equations (8) and (9).

T_{C}=S×Tₐ/(S−a)−a×T_{S}/(S−a) (10)

T_{C}=S×T_{b}/(S−b)−b×T_{S}/(S−b) (11)

If the internal temperature T_{C} is removed from Equations (10) and (11) which are then solved for the skin temperature T_{S}, this leads to Equation (12).

{−(S−a)+(S−b)×T_{S})=(S−b)×Tₐ−(S−a)×T_{b} (12)

Here, as a relationship between the coefficients a, b and S, a heat balance relative coefficient D expressed by the following Equation (13) is introduced.

D=(S−a)/(S−b) (13)

The heat balance relative coefficient D is data (coefficient) indicating a relative relationship between the respective heat balance characteristics at the first detection position P₁, the second detection position P₂, and the measurement target position P_{S}. In this case, Equation (12) may be rewritten into Equation (14) using the heat balance relative coefficient D.

T_{S}=Tₐ/(1−D)−D×T_{b}/(1−D) (14)

In Equation (14), the first detected temperature Tₐ and the second detected temperature T_{b} are temperatures which are respectively detected by the first temperature sensor 11 and the second temperature sensor 12. The skin temperature T_{S} may be detected using any separate method. However, the thermal resistors Rₐ₁, Rₐ₂, R_{b1}/R_{b2}, R_{S1}, and R_{S2} related to the first heat flow passage, the second heat flow passage, and the third heat flow passage are unknown, and thus a value of the heat balance relative coefficient D is also unknown. Therefore, in the present embodiment, a value of the heat balance relative coefficient D is obtained as follows.

In other words, if Equation (14) is solved for the heat balance relative coefficient D, the following Equation (15) is obtained.

D=(Tₐ−T_{S})/(T_{b}−T_{S}) (15)

As can be seen from Equation (15), the heat balance relative coefficient D is a ratio of a difference between the skin temperature T_{S} and the first detected temperature Tₐ to a difference between the skin temperature T_{S} and the second detected temperature T_{b}. If the skin temperature T_{S} measured according to any separate method is set as a reference skin temperature T_{SO}, and the first detected temperature Tₐ and the second detected temperature T_{b} at the time of measuring the reference skin temperature T_{SO} are respectively set as a reference first detected temperature T_{aO} and a reference second detected temperature T_{bO}, the heat balance relative coefficient D may be calculated as in the following Equation (16).

D=(T_{aO}−T_{SO})/(T_{bO}−T_{SO}) (16)

A value of the heat balance relative coefficient D calculated according to Equation (16) is stored. Then, the first detected temperature Tₐ and the second detected temperature T_{b} are continuously detected, and the skin temperature T_{S} is continuously calculated according to Equation (14) using the first detected temperature Tₐ and the second detected temperature T_{b} which have been detected, and the heat balance relative coefficient D. This operation corresponds to the “calculation” of a temperature.

### 1-2. Installation Position of Temperature Sensor

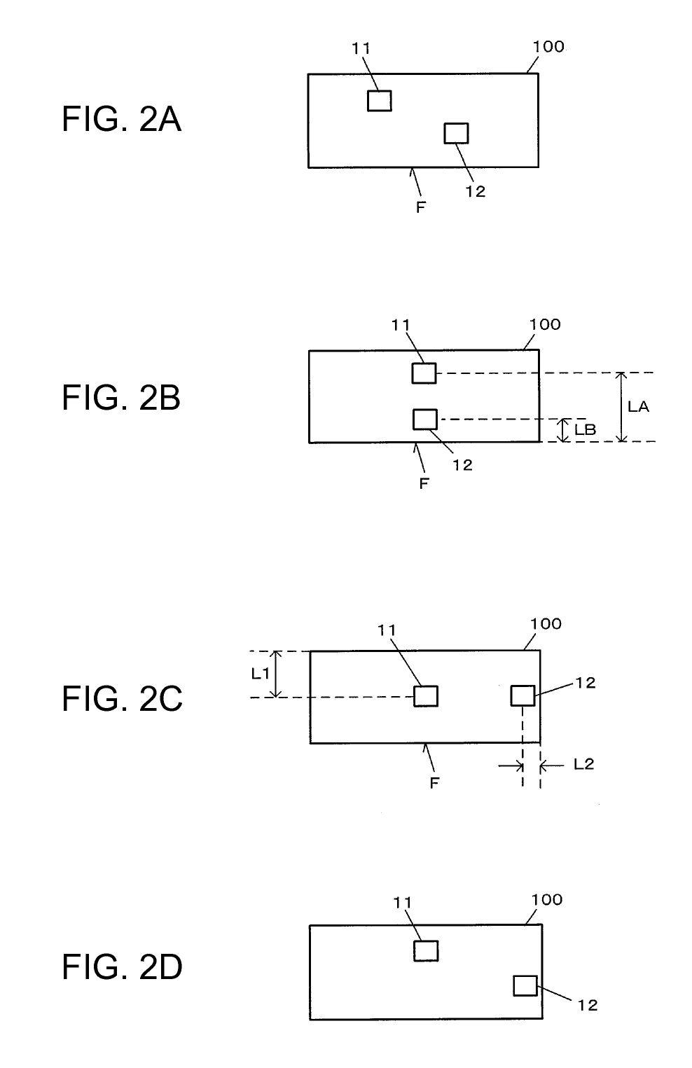

With reference to FIGS. 2A to 2D, an installation position of the temperature sensor will be described. An installation position of the temperature sensor is a position which is different from a position of a heat source (in this case, the inside of the living body) and whose temperature changes when a temperature of the heat source changes. Therefore, the first temperature sensor 11 and the second temperature sensor 12 may be fundamentally installed at two certain different locations in the base 100, for example, as illustrated in FIG. 2A. Since it is physically impossible that installation positions of two different temperature sensors are the same as each other, detected temperatures in the first temperature sensor 11 and the second temperature sensor 12 are fundamentally expected to be different from each other. In other words, it is expected that a temperature difference occurs between detected temperatures in the first temperature sensor 11 and the second temperature sensor 12 even if the temperature difference is little. Therefore, a surface temperature of the body to be measured can be calculated according to the above-described principle. In the present embodiment, the surface temperature is a temperature of a measurement target position, and it is assumed that the measurement target position is different from a position of the heat source (in this case, the inside of the living body) and is different from an installation position of the temperature sensor.

The installation positions of the first temperature sensor 11 and the second temperature sensor 12 are positions where heat balance characteristics inside the base 100 are different from those outside the base 100. In other words, assuming a heat flow passage from the heat source to the external world, the first temperature sensor 11 and the second temperature sensor 12 are installed at positions where heat conduction characteristics from the heat source to the positions are different from each other. The heat conduction characteristics are characteristics of heat conduction defined by characteristic values indicating the heat conduction, such as thermal conductivity or thermal resistivity which is an inverse number thereof.

Specifically, (i) if the first temperature sensor 11 and the second temperature sensor 12 are installed at positions (hereinafter, referred to as a “first position condition”) where the heat conduction characteristics from the contact surface F of the base 100 to the positions are different from each other, the positions are positions where heat balance characteristics inside the base 100 are different from those outside the base 100. (ii) If the first temperature sensor 11 and the second temperature sensor 12 are installed at positions (hereinafter, referred to as a “second position condition”) where the heat conduction characteristics from a side surface other than the contact surface F of the base 100 to the positions are different from each other, the positions are positions where heat balance characteristics inside the base 100 are different from those outside the base 100. Therefore, preferably, installation positions of the temperature sensors are selected so as to satisfy the first position condition or the second position condition, or both of the first position condition and the second position condition. This indicates that the base 100 includes the temperature sensors at (1) positions where the heat conduction characteristics from the contact surface F contacting the skin surface to the positions are different from each other, at (2) positions where the heat conduction characteristics from the side surface other than the contact surface F to the positions are different from each other, or at the positions of (1) and (2).

A description will be made of several examples satisfying the above-described conditions. For example, as illustrated in FIG. 2B, if a distance from the contact surface F to the first temperature sensor 11 is denoted by LA, an installation position is set so that a distance from the contact surface F to the second temperature sensor 12 becomes LB (<LA). Herein, the first temperature sensor 11 and the second temperature sensor 12 are installed in a normal direction of the contact surface F. In this case, since the installation positions of the temperature sensors 11 and 12 from the contact surface F are different from each other, the heat balance characteristics at the positions of the temperature sensors 11 and 12 are different from each other. Therefore, a difference (temperature difference) can be caused to occur in two detected temperatures.

FIG. 2C illustrates another example. The first temperature sensor 11 is disposed at the center of the base 100, and the second temperature sensor 12 is disposed near a circumference of the base 100. However, distances of the first temperature sensor 11 and the second temperature sensor 12 from the contact surface F are substantially the same as each other. In this case, the first temperature sensor 11 has L1 as a distance to the nearest side surface (an upper side surface in FIG. 2C) among side surfaces other than the contact surface F of the base 100. The second temperature sensor 12 has L2 (<L1) as a distance to the nearest side surface (a right side surface in FIG. 2C) among the side surfaces other than the contact surface F of the base 100. In this case, the heat balance characteristics are different from each other at the positions of the temperature sensors 11 and 12, and thus a difference can be caused to occur in two detected temperatures.

An arrangement as illustrated in FIG. 2D maybe used by combining the examples illustrated in FIGS. 2B and 2C with each other.

### 1-3. Configuration Examples of Base

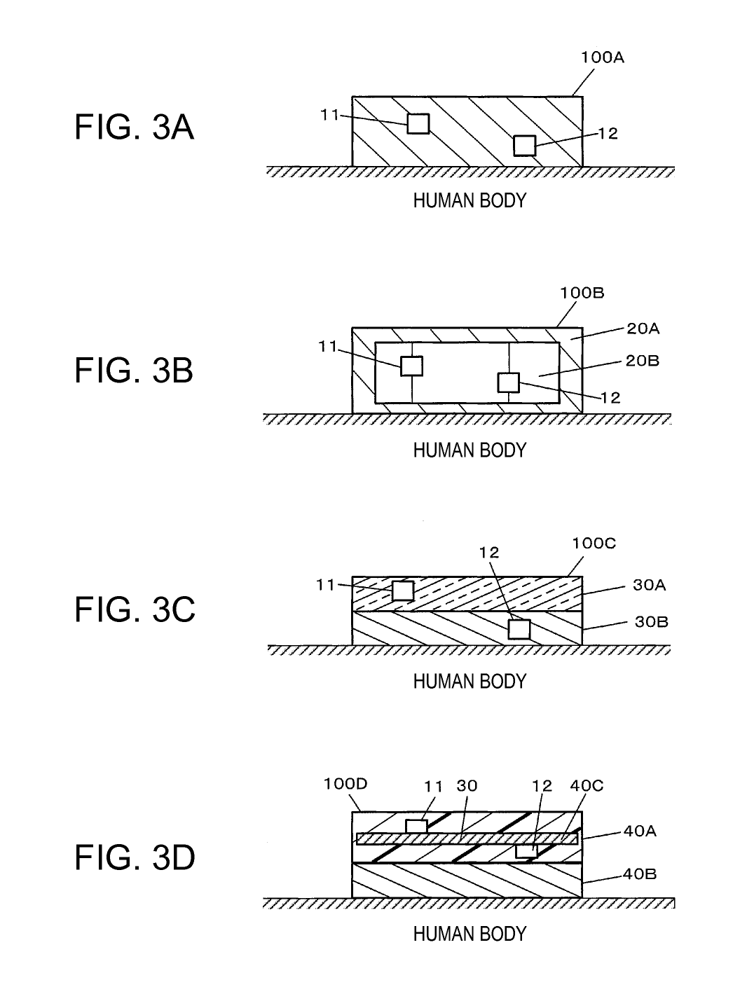

FIGS. 3A to 3D are sectional views schematically illustrating several configurations of the base 100.

FIG. 3A is a diagram illustrating a schematic configuration of a base 100A as the simplest configuration example of the base 100. The base 100A illustrated in FIG. 3A has abase material such as silicon rubber, and is configured so that the first temperature sensor 11 and the second temperature sensor 12 are installed at different positions inside the base material. A method of determining an installation position of each temperature sensor is the same as described with reference to FIGS. 2A to 2D, and this is also the same for FIGS. 3B to 3D.

FIG. 3B is a diagram illustrating a schematic configuration of a base 100B. In the base 100B, a housing 20A is formed to have an internal space 20B in a box-like (case) frame 20A made of, for example, resin or metal, the first temperature sensor 11 and the second temperature sensor 12 are fixed inside the internal space 20B with string-shaped members, and the internal space 20B is sealed with a predetermined gas. It can be said that the base 100B has a layered structure of the frame 20A and the internal space 20B.

FIG. 3C is a diagram illustrating a schematic configuration of a base 1000. The base 100C is configured by stacking a first layer 30A and a second layer 30B made of materials with different thermal conductivities. As materials of the first layer 30A and the second layer 30B, materials with different thermal conductivities may be selected as appropriate. The first temperature sensor 11 is installed in the first layer 30A, and the second temperature sensor 12 is installed in the second layer 30B.

FIG. 3D is a diagram illustrating a schematic configuration of a base 100D. The base 100D is configured by stacking a first layer 40A and a second layer 40B, and a circuit board 40C in which the first temperature sensor 11 is disposed on its upper surface and the second temperature sensor 12 is disposed on its lower surface is fixed to the first the layer 40A. A processor or a memory may be mounted on the circuit board 40C.

Various configurations of the base 100 have been illustrated and described but are only examples. For example, the illustrated configurations may be combined with each other. For example, there may be a configuration in which two circuit boards are disposed in a layer form inside the frame 20A as illustrated in FIG. 3B, the first temperature sensor 11 is disposed on one circuit board, and the second temperature sensor 12 is disposed on the other circuit board.

### 1-4. Principle of Temperature Estimation

A surface temperature of a body to be measured can be calculated according to the above-described principle of temperature calculation, but some time is required after the base 100 is brought into contact with the body to be measured until a temperature (that is, a temperature of the installation position of the temperature sensor) inside the base 100 is stabilized and reaches a steady state. Since the first detected temperature Tₐ, in the first temperature sensor 11 and the second detected temperature T_{b} in the second temperature sensor 12 change during a transient state before the steady state, there is a concern that an inaccurate temperature may be calculated if the skin temperature T_{S} is obtained according to Equation (14) using the first detected temperature Tₐ and the second detected temperature T_{b} at this time.

Therefore, a technique for estimating a temperature in the steady state from a temperature in the transient state is introduced. Specifically, in the present embodiment, an expression of non-steady thermal conduction is used which is obtained from a thermal conduction equation. If, as temperatures calculated with time differences, the skin temperature T_{S} calculated at a time point t₁ is referred to as a first skin temperature T_{S1}, and the skin temperature T_{S} calculated at a time point t₂ is referred to as a second skin temperature T_{S2}, a steady skin temperature T_{SX} can be estimated using the following Equation (17). This operation is the “estimation” of a temperature.

$${T}_{SX} = \frac{{T}_{S 2} - {T}_{S 1} \times exp ( - \frac{{t}_{2} - {t}_{1}}{R \times C} )}{1 - exp ( - \frac{{t}_{2} - {t}_{1}}{R \times C} )} \qquad ( 17 )$$

Here, R is a thermal resistance constant and is predefined, and C is a thermal capacity constant and is predefined. Each of the thermal resistance constant R and the thermal capacity constant C may be predefined, and a value of R×C may be predefined. Specifically, the following initial setting may be performed. For example, when a skin temperature measured according to any separate method is set as the steady skin temperature T_{SX}, and the skin temperatures T_{S} which are calculated using the above-described Equation (14) on the basis of the first detected temperature Tₐ and the second detected temperature T_{b} detected at different timings in the transient state (non-steady state) are respectively set as the first skin temperature T_{S1} and the second skin temperature T_{S2}, a value of R×C is obtained by performing backward calculation using Equation (17). A method of selecting this value as a value of R×C used for the “estimation” may be employed.

If a value of R×C can be treated as a constant value regardless of subjects, a default may be used. In this case, if it is preferable to change a value of R×C depending on a measurement target part, a default corresponding to the measurement target part may be selected and set.

In the “estimation” process, a temperature can be effectively obtained not only in the transient state (non-steady state) but also in the steady state. For this reason, in the present embodiment, a temperature obtained during the “estimation” process is assumed to be output as a surface temperature (output value) of a body to be measured at all times. However, in a case where a predetermined stabilization condition in which a change in a “calculated” temperature is not considerable is satisfied, the “estimation” process may be omitted, the “calculated” temperature may be used as an output value.

### 1-5. Test Result

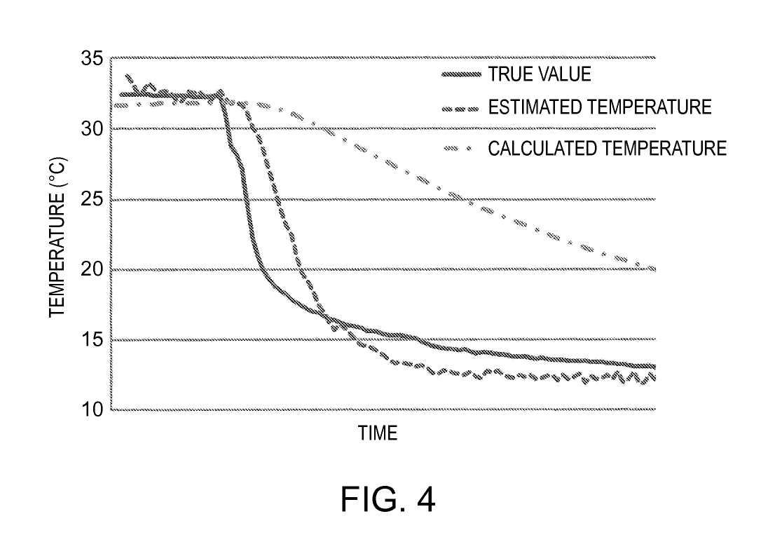

FIG. 4 is a diagram illustrating an example of a result of performing a test for verifying the above-described principle. A simple human body tissue model which was created by coating an aluminum block with polyvinyl chloride at a predetermined thickness was used as a body to be measured. The human body tissue model was placed in a stationery state in a constant-temperature water tank of which an amount of water was adjusted so that most of the human body tissue model was located under the water and only an upper layer portion of the human body tissue model was located on the water. The base 100 was installed by contacting the contact surface F with a surface of the portion located on the water. A water temperature was 37 degrees.

In the test, first, the constant-temperature water tank in which the human body tissue model was placed in a stationery state stood still in a state in which an atmosphere temperature thereof was constant as 25 degrees for a sufficient time or more for which a temperature of the human body tissue model and a temperature (that is, a temperature of the installation position of the temperature sensor) of the base 100 reached a steady state. Then, the human body tissue model and the base 100 were transferred to a constant-temperature tank whose atmosphere temperature is maintained at 0 degrees for each constant-temperature water tank in which the human body tissue model was placed in a stationery state. FIG. 4 illustrates temperatures which are calculated and estimated according to the above-described principle before and after the process.

In FIG. 4, a solid line indicates a true value, a dot chain line indicates a temperature (calculated temperature) calculated using Equation (14), and a dashed line indicates a temperature (estimated temperature) estimated using Equation (17). In the graph illustrated in FIG. 4, a time point at which the true value near original 32.5 degrees starts to decrease is a time point at which the constant-temperature water tank is changed, that is, the atmosphere temperature is changed. Although not illustrated in FIG. 4, since both of the calculated temperature and the estimated temperature finally reached the steady state, it can be confirmed that an accurate temperature can be obtained in both of the temperature calculation using Equation (14) and the temperature estimation using Equation (17). Here, as illustrated in FIG. 4, it can be seen that the estimated temperature reaches a stable temperature earlier than the calculated temperature and thus a temperature in the steady state is obtained early. During the transient state before reaching the steady state, the estimated temperature changes so as to track the change in the true value with high responsiveness, and thus it can be said that the estimated temperature can also cause a more reliable temperature which are closer to the true value, to be obtained during the transient state than the calculated temperature.

The effectiveness of the temperature measurement method of the present embodiment is verified from the test result.

### 2. EXAMPLES

Next, a description will be made of Examples of a temperature measurement apparatus 1 which measures a surface temperature of a body to be measured according to the above-described principle. Here, as an example, a description will be made of a case where the human body is used as a body to be measured, and a skin temperature (a temperature of a measurement target position) is measured by contacting the base 100 with a skin surface of the wrist. A contact part is not limited to the wrist, and may be not only the limbs such as the upper arm or the lower arm, the thigh, and the ankle but also certain part surfaces (skin surfaces) of the head, the neck, the trunk part, and the like.

### 2-1. Functional Configuration

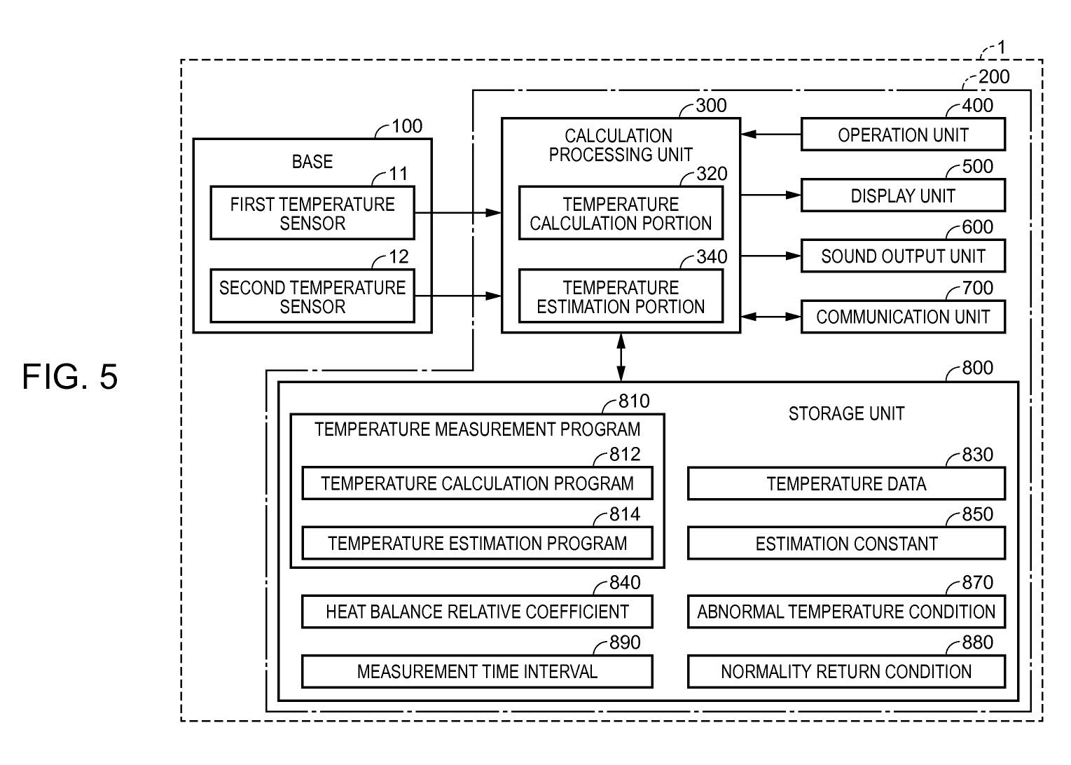

FIG. 5 is a block diagram illustrating an example of a schematic configuration of the temperature measurement apparatus 1 according to the present embodiment. The temperature measurement apparatus 1 includes the base 100 and a main body processing block 200. Although not illustrated, if the temperature measurement apparatus 1 is provided with a battery, the temperature measurement apparatus 1 can be carried and is thus considerably convenient. A principle configuration of the base 100 is the same as described above.

The base 100 and the main body processing block 200 may be provided integrally with or separately from each other. If the base 100 and the main body processing block 200 are provided separately from each other, the base 100 is configured as, for example, a probe. In this case, the entire shape of the base 100 may be a planar shape (for example, a button shape or a sheet shape), and may be a tubular shape so that the base 100 can be gripped with one hand. The base 100 and the main body processing block 200 may be connected to each other in a wired manner via a cable. A small radio unit may be built into the base 100 which is thus connected to the main body processing block 200 in a wireless manner. The base 100 may be provided with a belt for fixing the base 100 to the limbs (including the wrist or the ankle), the trunk part, or the neck, and may be provided with an adhesive tape which is exchangeable.

If the base 100 and the main body processing block 200 are provided integrally with each other, preferably, for example, a belt is provided in order to fix the base 100 and the main body processing block 200 to the limbs (including the wrist or the ankle), the trunk part, or the neck. In this case, a casing of the temperature measurement apparatus 1 may be used in common to the base 100, and thus the configuration as illustrated in FIG. 3D may be employed. Specifically, a frame of the temperature measurement apparatus 1 is constituted of a case made of plastic, metal, or the like, and a board for operating and controlling each unit of the main body processing block 200 is fixed and disposed inside the case. The first temperature sensor 11 and the second temperature sensor 12 may be mounted on the board. Of course, a board for mounting the first temperature sensor 11 and the second temperature sensor may be provided separately, and separate boards for respectively mounting the first temperature sensor 11 and the second temperature sensor 12 may be provided.

The main body processing block 200 includes, for example, a calculation processing unit 300, an operation unit 400, a display unit 500, a sound output unit 600, a communication unit 700, and a storage unit 800.

The calculation processing unit 300 is a control device and a calculation device which collectively control each unit of the temperature measurement apparatus 1 according to various programs such as a system program stored in the storage unit 800, and is constituted of, for example, a processor such as a central processing unit (CPU) or a digital signal processor (DSP).

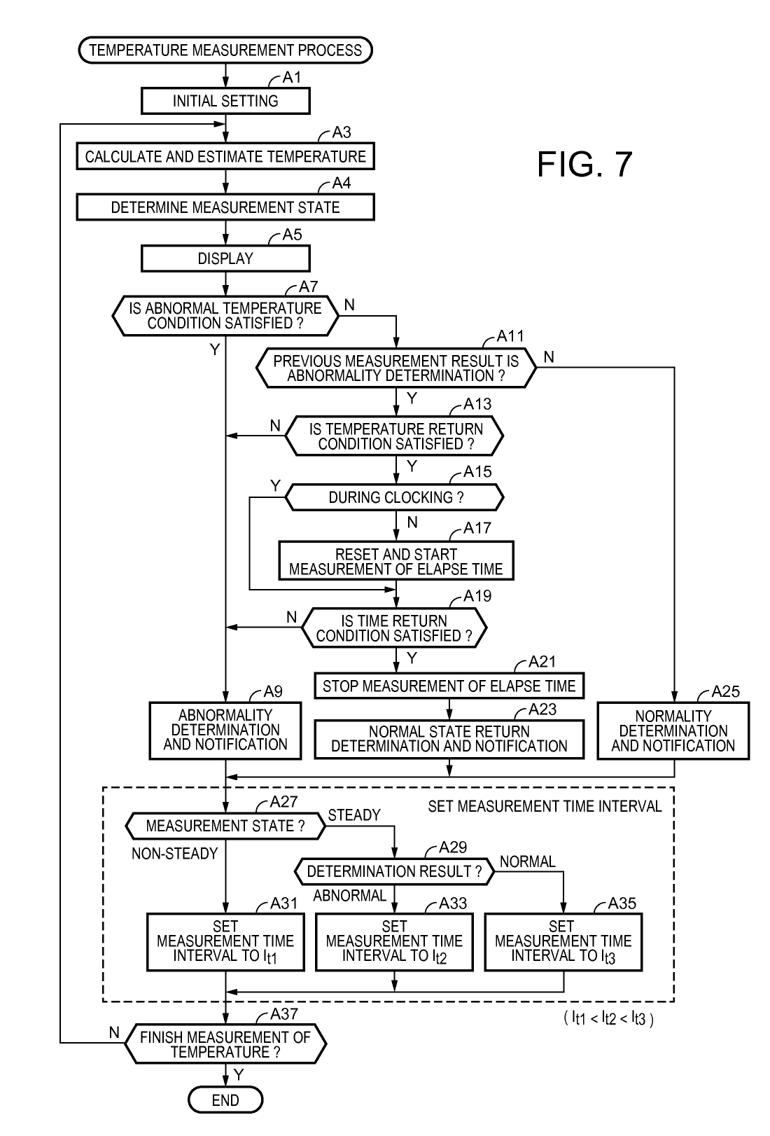

The calculation processing unit 300 includes a temperature calculation portion 320 and a temperature estimation portion 340 which continuously measure a temperature of the body to be measured as main functional portions, and performs a temperature measurement process which will be described with reference to FIG. 7, according to a temperature measurement program 810. The calculation processing unit 300 has a clocking function of counting time points.

The temperature calculation portion 320 calculates a temperature according to the above Equation (14) using a heat balance relative coefficient 840 which is set in advance in the initial setting, and detected temperatures indicated by the temperature detection signals from the first temperature sensor 11 and the second temperature sensor 12.

The temperature estimation portion 340 estimates a temperature according to Equation (17) using calculated temperatures which are calculated at different timings, specifically, the previous measurement timing and the present measurement timing by the temperature calculation portion 320. The thermal resistance constant R and the thermal capacity constant C, or a value of R×C (hereinafter, collectively referred to as “estimation constants”) are initially set and are set as an estimation constant 850 in the storage unit 800.

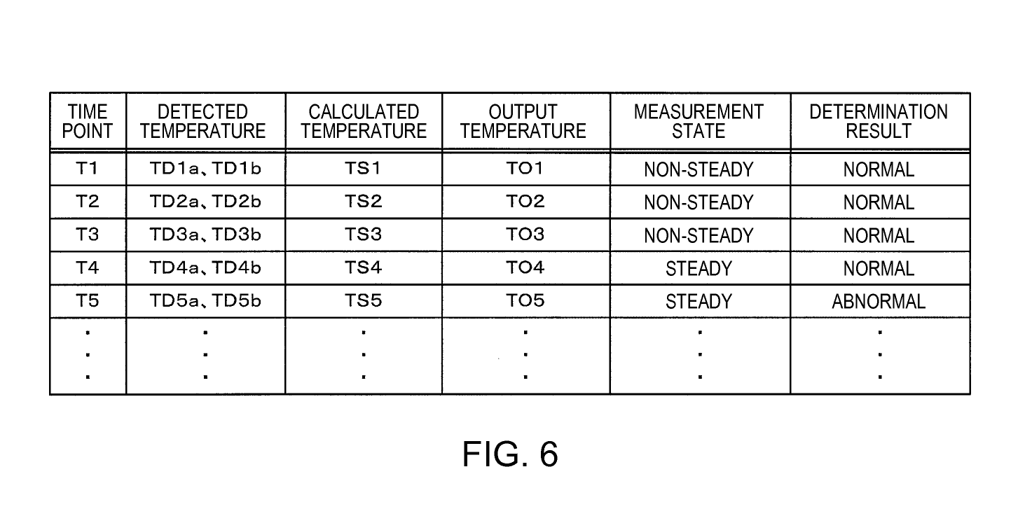

In the present example, the temperature estimation portion 340 is assumed to operate at all times in order to measure a temperature. For this reason, a temperature estimated by the temperature estimation portion 340 is stored in temperature data 830 (refer to FIG. 6) of the storage unit 800 as an output temperature which is a measurement result.

The operation unit 400 is an input device including a switch and the like, and outputs a signal corresponding to the pressed switch to the calculation processing unit 300. The operation unit 400 is used to input a set value for initial setting, or to input various instruction operations such as starting and finishing of temperature measurement.

The display unit 500 is a display device which includes a liquid crystal display (LCD) and the like, and performs various display based on display signals which are input from the calculation processing unit 300. The display unit 500 displays an output temperature which is a measurement result, identification of whether a measurement state is a non-steady state or a steady state, identification of whether or not a measured temperature is abnormal or normal, and the like.

The sound output unit 600 includes a speaker and reproduces and outputs sound on the basis of a sound signal which is input from the calculation processing unit 300. The sound output unit 600 outputs identification sound of whether a measured temperature is abnormal or normal, various notification sound, and the like. The sound mentioned here also includes voice.

The communication unit 700 is a communication device which transmits and receives information used in the apparatus to and from an external information processing apparatus such as a personal computer (PC) under the control of the calculation processing unit 300. As a communication method of the communication unit 700, various methods maybe employed, such as a method of performing wired connection via a cable conforming to a predetermined standard, and a method of performing wireless connection using near field communication.

The storage unit 800 includes a storage device such as a read only memory (ROM), a flash ROM, and a random access memory (RAM). The storage unit 800 stores a system program of the temperature measurement apparatus 1, various programs for realizing various functions such as a temperature calculation function, a temperature estimation function, and a communication function, data, and the like.

The storage unit 800 stores, as a program, the temperature measurement program 810 which is read by the calculation processing unit 300 and is executed as the temperature measurement process (refer to FIG. 7). The temperature measurement program 810 includes, as subroutines, a temperature calculation program 812 for calculating a temperature and a temperature estimation program 814 for estimating a temperature according to the above-described principle. The temperature measurement process will be described later in detail with reference to a flowchart.

The storage unit 800 stores, as data, the temperature data 830, the heat balance relative coefficient 840, the estimation constant 850, an abnormal temperature condition 870, a normality return condition 880, and a measurement time interval 890.

The temperature data 830 has, for example, a data structure illustrated in FIG. 6. In other words, the temperature data 830 stores detected temperatures based on temperature detection signals which are respectively input from the first temperature sensor 11 and the second temperature sensor 12, a calculated temperature which is calculated using the detected temperatures, an output temperature (output value) which is estimated using the calculated temperature and is output as a result of the measurement, a measurement state indicating whether a measurement state is a non-steady state or a steady state, and a determination result of whether the output temperature is normal or abnormal, in correlation with each time point of the measurement timing. Therefore, the temperature data 830 can be said to be history data of each value. Here, the time point indicates a time point (timing) at which a temperature is measured. The measurement state is determined on the basis of the progress of a change in a calculated temperature. For example, a temperature change speed is obtained on the basis of a difference between the previous and present calculated temperatures, and a calculation time interval. If the temperature change speed enters a specific value range, a steady state is determined, and otherwise, a non-steady state is determined.

The heat balance relative coefficient 840 is a value of the above-described heat balance relative coefficient D. The heat balance relative coefficient 840 is set in initial setting. The estimation constant 850 indicates values of the thermal resistance constant R and the thermal capacity constant C, or a value of R×C, and the values are also set in the initial setting.

The abnormal temperature condition 870 is a condition for determining whether or not an output temperature is abnormal. For example, the condition is, for example, an OR condition of a high temperature side condition (for example, 38 degrees or higher) and a low temperature side condition (for example, 27 degrees or lower). Abnormality is determined in a case of a high temperature or a low temperature.

The normality return condition 880 is a condition for determining whether or not an output temperature returns to a normal temperature after abnormality is determined since the abnormal temperature condition 870 is satisfied. The normality return condition 880 includes a condition regarding a temperature (temperature return condition) and a condition regarding time (time return condition). The temperature return condition is a condition with a threshold value closer to a normal value than a threshold value of the abnormal temperature condition 870. For example, the temperature return condition is that a temperature is included in a temperature range from 30 degrees or higher as the low temperature side condition to below 37.5 degrees as the high temperature side condition. The time return condition is a condition for determining whether or not a state satisfying the temperature return condition lasts for a predetermined period of time, and one minute or more is defined as the condition. Thus, the normality return condition 880 is that the duration of the state satisfying the temperature return condition satisfies the time return condition.

The measurement time interval 890 is a time interval at which temperature measurement is performed. The measurement time interval 890 is changed depending on whether a measurement state is a steady state or a non-steady state (transient state) or whether a determination result is normality determination (normal temperature) or abnormality determination (abnormal temperature). Specifically, the time interval is set to be shorter in the non-steady state than in the steady state. The time interval is set to be shorter in the abnormality determination than in the normality determination.

Setting of the measurement time interval 890 is not limited thereto. In a case where the normality determination or the steady state lasts, the time interval maybe gradually lengthened up to a predetermined maximum time interval. In a case where a determination result changes from the normality determination to the abnormality determination, the time interval may be switched to a predetermined minimum time interval, and in a case where the abnormality determination lasts, the time interval may be gradually lengthened up to a predetermined abnormality time interval. When measurement is started, a measurement time interval maybe set to the minimum time interval, and may be gradually lengthened up to a predetermined non-steady state standard time interval according to a period of time for which the non-steady state lasts during the non-steady state. If the time interval is lengthened, power can be saved.

### 2-2. Flow of Temperature Measurement Process

FIG. 7 is a flowchart illustrating a flow of the temperature measurement process which is performed by the calculation processing unit 300 according to the temperature measurement program 810 stored in the storage unit 800.

First, the calculation processing unit 300 performs initial setting (step A1). Here, the heat balance relative coefficient 840 is set. A value of the heat balance relative coefficient 840 may be set through an input operation on the operation unit 400. An accurate temperature of the measurement target position, measured using a separate device, maybe input, and the calculation processing unit 300 may obtain and set the heat balance relative coefficient 840 on the basis of the temperature, and detected temperatures in the first temperature sensor 11 and the second temperature sensor 12. In the latter case, the heat balance relative coefficient 840 can be calculated according to the above Equation (16).

The estimation constant 850 is also set in the initial setting.

Next, the temperature calculation portion 320 acquires detected temperatures in the respective temperature sensors by receiving temperature detection signals from the base 100, stores the detected temperatures in the storage unit 800, and calculates a temperature of the measurement target position using the detected temperatures and the heat balance relative coefficient 840 (step A3). The temperature estimation portion 340 estimates a temperature of the measurement target position using a calculated temperature which is calculated at the previous measurement timing by the temperature calculation portion 320 and a calculated temperature which is calculated at the present measurement timing by the temperature calculation portion 320 (step A3). The estimated temperature is used as a measurement result at the present measurement timing, and is stored in the storage unit 800 as an output temperature. The calculated temperature obtained in the process of obtaining the output temperature is also stored in the storage unit 800 in correlation with a measurement time point.

Next, the calculation processing unit 300 determines a measurement state on the basis of the progress of the calculated temperature and stores the determined measurement state in the storage unit 800 (step A4). The output temperature is displayed on the display unit 500 (step A5). In this case, the determined measurement state may be displayed.

If the output temperature satisfies the abnormal temperature condition 870 (YES in step A7), the calculation processing unit 300 determines that the temperature is abnormal, and performs a notification of the abnormal temperature (step A9). If the output temperature does not satisfy the abnormal temperature condition 870 (NO in step A7), the calculation processing unit 300 determines whether or not the measurement result at the previous measurement timing is abnormality determination (step A11). If the measurement result at the previous measurement timing is abnormality determination (YES in step A11), it is determined whether or not the present output temperature satisfies the temperature return condition of the normality return condition 880 (step A13). Here, if a determination result is negative (NO in step A13), abnormality is determined (step A9). This case indicates that the present output temperature is not abnormal but is determined as being abnormal until it is continuously determined that the present output temperature is not abnormal since the previous determination is abnormality determination.

If it is determined that the temperature return condition is satisfied (YES in step A13), the duration of the state determined as satisfying the temperature return condition is measured (steps A15 to A17). In other words, if the duration is not measured, measurement of elapse time is reset so as to be started.

If the measured elapse time satisfies the time return condition (YES in step A19), the measurement of the elapse time is stopped (step A21), the output temperature is determined as returning to a normal temperature, and a notification thereof is performed (step A23). If the time return condition is not satisfied (NO in step A19), the calculation processing unit 300 continuously determines abnormality in a wait-and-see state in step A9.

If the previous determination result is not abnormality determination in step A11 (NO in step A11), normality is determined, and a notification thereof is performed (step A25).

After any one of steps A9, A23, and A25, the calculation processing unit 300 sets the measurement time interval 890. In other words, if a measurement state is the non-steady state (the non-steady state in step A27), a time interval Iₜ₁ is set as the measurement time interval 890 (step A31). In a case where the measurement state is the steady state (the steady state in step A27), a time interval Iₜ₂ is set as the measurement time interval 890 if a determination result is abnormality determination, and a time interval Iₜ₃ is set as the measurement time interval 890 if the determination result is normality determination (steps A33 and A35). The time intervals satisfy Iₜ₁<Iₜ₂<Iₜ₃.

It is determined that the next measurement timing occurs on the basis of the set measurement time interval 890, the calculation processing unit 300 causes the process to proceed to step A3, and it is determined that the temperature measurement is finished, the calculation processing unit 300 finishes the temperature measurement process (step A37).

### 2-3. Operations and Effects

According to the temperature measurement apparatus 1, it is possible to calculate a surface temperature of a body to be measured using temperatures detected by a plurality of temperature sensors which are provided at different positions inside the base 100.

The temperature sensors 11 and 12 are installed at positions where the heat balance characteristics inside the base 100 are different from those outside the base 100. Looking at a physical structure of the base 100, the base 100 includes the temperature sensors 11 and 12 at (1) positions where the heat conduction characteristics from the contact surface F contacting the body to be measured to the positions are different from each other, at (2) positions where the heat conduction characteristics from the side surface other than the contact surface F to the positions are different from each other, or at the positions of (1) and (2). Thus, the heat balance characteristics at the positions of the temperature sensors 11 and 12 are different from each other, and, as a result, a difference (temperature difference) can be caused to occur in two detected temperatures in the temperature sensors 11 and 12. As the temperature difference becomes greater, a relative relationship between the heat balance characteristics at the positions of the temperature sensors 11 and 12 is more clearly reflected in the heat balance relative coefficient D. Therefore, it is possible to measure a surface temperature of the body to be measured with high accuracy.

In the temperature measurement, a temperature in a steady state is “estimated” from a temperature which is temporarily “calculated” in consideration of a case of a non-steady state (transient state) in which a temperature of the base 100 does not reach the steady state. Thus, it is possible to obtain a highly accurate temperature even in the non-steady state (transient state) in which the base 100 has just come into contact with a skin surface.

### 3. MODIFICATION EXAMPLES

Examples to which the invention is applicable are not limited to the above-described Examples, and may be modified as appropriate within the scope without departing from the spirit of the invention. In the following modification examples, the same constituent elements as in the above-described Examples or the same steps as in the flowchart are given the same reference numerals, and repeated description thereof will be omitted.

### 3-1. Number of Installed Temperature Sensors

In the above-described embodiment, a description has been made of a case where two temperature sensors are installed inside the base 100 as an example, but three or more temperature sensors may be installed at different positions. In this case, as heat flow passage models as described with reference to FIGS. 1A to 1C, heat flow passages corresponding to the number of installed temperature sensors are assumed, and modeling may be performed in the same manner as in the above-described embodiment.

In other words, in a case where n (where n≧2) temperature sensors are installed inside the base 100, heat flow passage models as illustrated in FIG. 1C are built for respective first to n-th heat flow passages. An expression of a temperature at each of first to n-th detection positions is formulated. Relative relationships of heat balance characteristics at the respective first to n-th detection positions are respectively defined as heat balance relative coefficients. Then, a surface temperature maybe measured in the same manner as in the above-described embodiment.

### 3-2. Selection of Temperature Sensor

Three or more temperature sensors may be installed at different positions inside the base 100, and at least two temperatures may be selected from the temperature sensors so as to measure a surface temperature of a body to be measured. For example, in a case where three temperature sensors are installed, two temperature sensors are selected therefrom so as to measure a temperature. For example, in a case where four temperature sensors are installed, two or three temperature sensors may be selected therefrom so as to measure a temperature. Herein, as an example, a description will be made of a case where three temperature sensors are installed inside the base 100.

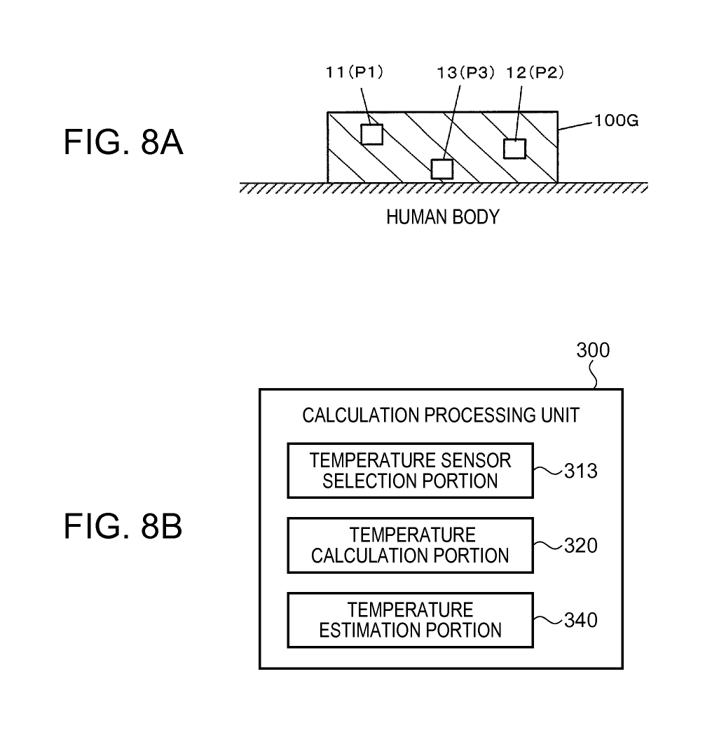

FIG. 8A is a diagram illustrating an example of a schematic configuration of a base 100G in the present modification example. The base 100G is configured by providing first to third temperature sensors 11, 12 and 13 at first to third detection positions P1, P2 and P3.

FIG. 8B is a diagram illustrating a functional configuration of the calculation processing unit 300 in the present modification example. The calculation processing unit 300 further includes a temperature sensor selection portion 313. The temperature sensor selection portion 313 selects two temperature sensors from the three temperature sensors.

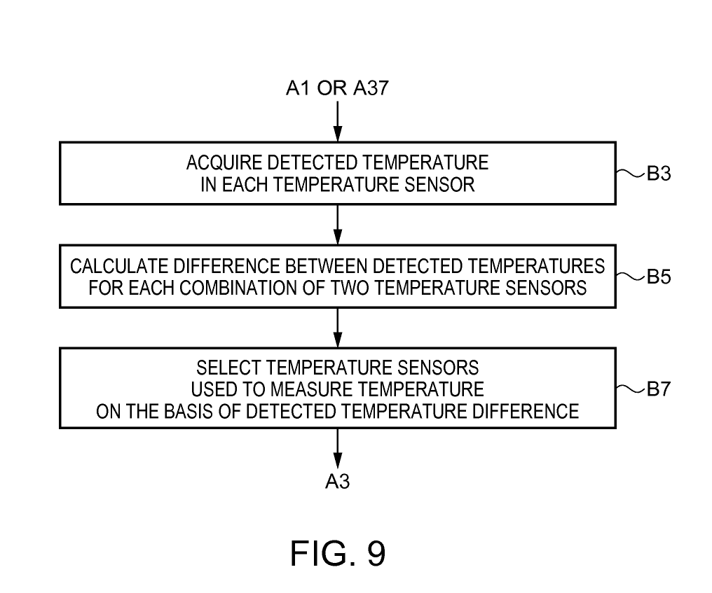

FIG. 9 is a flowchart illustrating a process which is additionally performed right before step A3 in the temperature measurement process illustrated in FIG. 7 by the calculation processing unit 300 of FIG. 8B in the present modification example.

After the process in step A1 or step A29 is performed, the calculation processing unit 300 acquires detected temperatures in the first to third temperature sensors 11 to 13 (step B3). A difference between the detected temperatures (hereinafter, referred to as a “detected temperature difference”) is calculated for each combination of two temperature sensors (step B5).

Next, the temperature sensor selection portion 313 determines a temperature sensor used to measure a temperature on the basis of the detected temperature difference which is calculated in step B5 (step B7). Specifically, for example, a combination of the temperature sensors in which the detected temperature difference is the maximum is determined, and two temperature sensors included in the combination are selected as temperature sensors used to measure a temperature.

In the next step A3, a temperature is calculated using the heat balance relative coefficient D corresponding to the combination of the temperature sensors used to measure a temperature, selected in step B7.

### 3-3. Calculation Formulae of Heat Balance Relative Coefficient and Surface Temperature

The calculation formulae of the heat balance relative coefficient and the surface temperature described in the embodiment are only examples and are not limited thereto.

### 3-4. Output Temperature

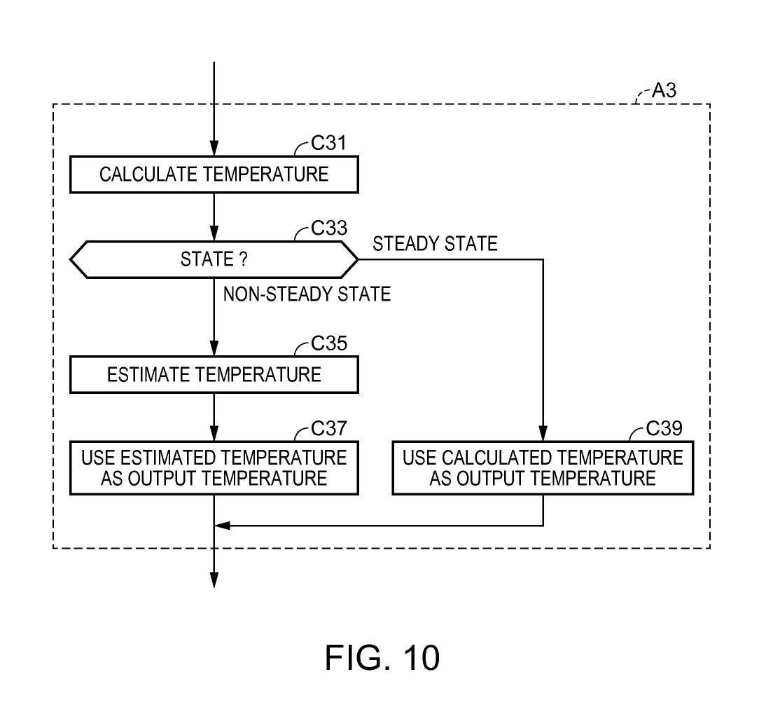

In the above-described embodiment, “estimation” of a temperature is performed at all times, and element estimated temperature is used as an output temperature. However, in the steady state, a calculated temperature which is “calculated” may be used as an output temperature. For example, this is realized by changing the process in step A3 of the temperature measurement process illustrated in FIG. 7 to a process illustrated in FIG. 10. In other words, after a temperature is calculated (step C31), it is determined whether or not a change in the calculated temperature is included in a predetermined range showing the steady state on the basis of transition of the calculated temperature stored in the temperature data 830, and thus it is determined whether the calculated temperature is in the steady state or in the non-steady state (step C33). The determination may be performed on the basis of a difference between a calculated temperature at the previous measurement timing and a calculated temperature at the present measurement timing, and may be performed on the basis of a difference between the maximum value and the minimum value of several calculated temperatures (for example, five calculated temperatures) in the past. If it is determined that the calculated temperature is in the steady state, the calculated temperature is used as an output temperature without estimating a temperature (step C39). On the other hand, if it is determined that the calculated temperature is in the non-steady state, temperature estimation is performed (step C35), and an estimated temperature is used as an output temperature (step C37).

### 3-5. “Calculation” and “Estimation”

In the embodiment, a description has been made of a case where a temperature is “estimated” using a calculated temperature which is “calculated” from the first detected temperature Tₐ and the second detected temperature T_{b}, but the following process may be performed. In other words, the “calculation” and the “estimation” are reversely performed. Instead of the first skin temperature T_{S1} at the time point t₁ and the second skin temperature T_{S2} at the time point t₂, a temperature is estimated according to Equation (17) using the first detected temperature Tₐ₁ at the time point t₁ and the first detected temperature Tₐ₂ at the time point t₂. The estimated temperature is referred to as a temperature Tₐ′. Similarly, a temperature is estimated according to Equation (17) using the second detected temperature T_{b1} at the time point t₁ and the second detected temperature T_{b2} at the time point t₂. The estimated temperature is referred to as a temperature T_{b}′. A temperature is calculated according to Equation (14) using the temperatures Tₐ′ and T_{b}′ instead of Tₐ and T_{b} of Equation (14). The calculated temperature may be used as an output temperature. The method of reversely performing the “calculation” and the “estimation” is preferably used in the non-steady state (transient state).

### 3-6. Measurement Target Position

In the above-described embodiment, a description has been made of a case where a skin is set as a measurement target position, and a surface temperature of a body to be measured is measured. However, as can be seen from the heat flow passage models illustrated in FIGS. 1B and 1C, a measurement target position is not required to be a surface of the body to be measured. For example, a specific position (for example, a position of a specific organ or a specific biotissue) located at a depth of a predetermined distance from a surface may be set as a measurement target position, and a temperature of the position may be measured (“calculated” or “estimated”). In this case, an embodiment may be implemented by replacing the “surface temperature” or the “skin temperature” in the above-described embodiment with a “temperature of the measurement target position”. Of course, in that case, values of the heat balance relative coefficient D, the thermal resistance constant R, the thermal capacity constant C, and R×C are values corresponding to the measurement target position.

A body to be measured is not required to be the human body, and may be organic objects (living body) such as animals other than the human body, or may be inorganic objects such as a furnace, a pipe, and an engine.

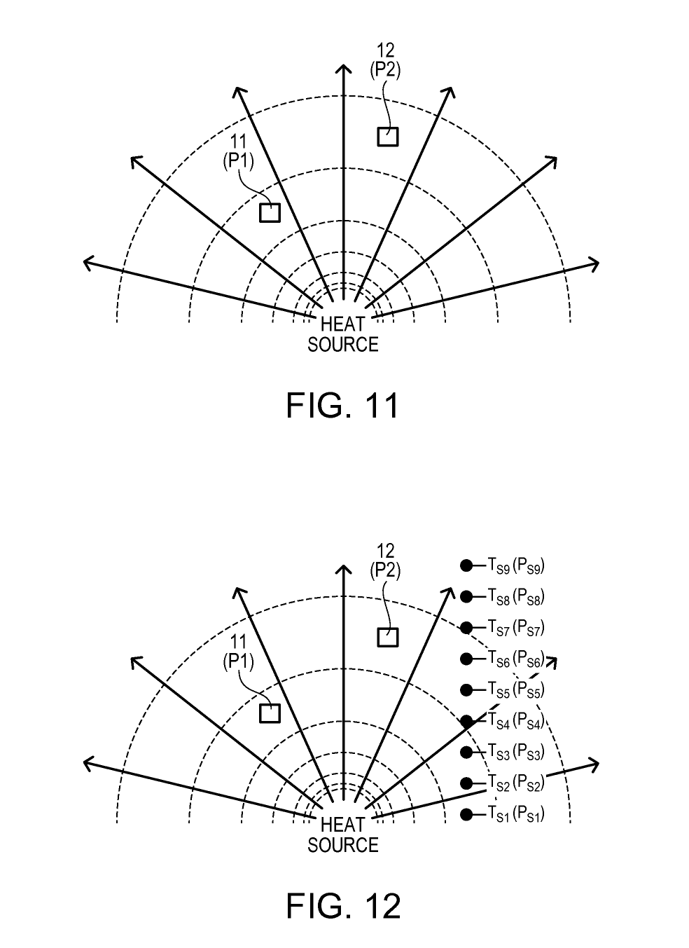

In the above-described embodiment, a description has been made of a case where the temperature sensor is installed inside the base, but the base is not required to be used. In other words, as illustrated in FIG. 11, the temperature sensors may be installed at positions which are different from a position of a predetermined heat source and whose temperatures change due to a change in a temperature of the heat source. In FIG. 11, concentric gray dash lines and arrows indicate heat flows (or which can be said to be temperature gradients). In the example illustrated in FIG. 11, the first temperature sensor 11 and the second temperature sensor 12 are installed at the first and second detection positions P1 and P2. For example, there may be a configuration in which a processor installed in a casing of a computer apparatus is a heat source, and temperature sensors are installed at different positions inside the casing. In this case, for example, any position inside the casing may be set as a measurement target position.

In the above-described embodiment, a description has been made of a case where the number of measurement target positions is one, but the number of measurement target positions is not required to be one. For example, a plurality of locations may be set as measurement target positions as illustrated in FIG. 12. In this case, temperatures of the measurement target positions can be calculated by applying the above-described embodiment to the respective measurement target positions. FIG. 12 illustrates an example of calculating temperatures T_{S1} to T_{S9} of measurement target positions P_{S1} to P_{S9}.

In the above-described embodiment, the description has been made on the premise that a heat source is a heat generation source, but a heat absorption source whose temperature is lower than a temperature of a surrounding environment may be employed.

The entire disclosure of Japanese Patent Application No.2014-184519, filed Sep. 10, 2014 is expressly incorporated by reference herein.

What is claimed is:

1. A temperature measurement apparatus comprising:
temperature sensors that are respectively provided at a plurality of positions which are different from a position of a predetermined heat source and of which temperatures change when a temperature of the heat source changes; and
a calculation processing unit that calculates a temperature of a measurement target position which is different from the position of the heat source and is different from installation positions of the temperature sensors of which temperatures change when a temperature of the heat source changes, using detected temperatures in the temperature sensors.

2. The temperature measurement apparatus according to claim 1,
wherein the calculation processing unit calculates a temperature of the measurement target position using relative relationship data indicating a relative relationship between heat balance characteristics at the measurement target position and the positions of the temperature sensors, and the detected temperatures in the temperature sensors.

3. The temperature measurement apparatus according to claim 2,
wherein the temperature sensors are three or more temperature sensors, and
wherein the calculation processing unit selects at least two temperature sensors from the temperature sensors, and calculates a temperature of the measurement target position using the relative relationship data related to a combination of the selected temperature sensors and detected temperatures in the selected temperature sensors.

4. The temperature measurement apparatus according to claim 1,
wherein the calculation processing unit estimates a temperature of the measurement target position in a steady state on the basis of a plurality of temperatures obtained by performing the calculation at different calculation timings.

5. The temperature measurement apparatus according to claim 4,
wherein the calculation processing unit uses a temperature obtained by performing the estimation as an output value in a case where temperatures of the positions of the temperature sensors are in a non-steady state.

6. The temperature measurement apparatus according to claim 4,
wherein the calculation processing unit uses a temperature obtained by performing the calculation as an output value in a case where temperatures of the positions of the temperature sensors are in a steady state.

7. The temperature measurement apparatus according to claim 1,
wherein the calculation processing unit estimates a detected temperature in a steady state on the basis of the detected temperatures at different calculation timings, and calculates a temperature of the measurement target position using the estimated detected temperature.

8. A temperature measurement method comprising:
detecting temperatures using temperature sensors which are respectively provided at a plurality of positions which are different from a position of a predetermined heat source and of which temperatures change when a temperature of the heat source changes; and
calculating a temperature of a measurement target position which is different from the position of the heat source and is different from installation positions of the temperature sensors of which temperatures change when a temperature of the heat source changes, using detected temperatures in the temperature sensors.
